(19) United States
(12) Patent Application Publication
(10) Pub. No.: US 2026/0091499 A1
(43) Pub. Date: Apr. 2, 2026

(54) SYSTEM AND METHOD FOR ASSEMBLING VEHICLE OR OTHER TARGET ASSEMBLY

(71) Applicants: Hyundai Motor Company, Seoul (KR); Kia Corporation, Seoul (KR)

(72) Inventor: Su Bin Cho, Hwaseong (KR)

(21) Appl. No.: 19/258,217

(22) Filed: Jul. 2, 2025

(30) Foreign Application Priority Data
Oct. 2, 2024 (KR) 10-2024-0133497

(51) Int. Cl. B25J 9/16

(52) U.S. Cl. CPC B25J 9/1687; B25J 9/1666; B25J 9/1671

(57) ABSTRACT

A system, method, and computer readable medium for assembling a target assembly such as a vehicle utilize a computer-aided design (CAD). The method for assembling the target assembly includes determining a disassembly sequence of the target assembly based on a CAD assembly that modeled the target assembly, determining an assembly sequence of the target assembly based on a comparison between the disassembly sequence and an assembly sequence of a pre-stored reference assembly, and generating an operation path of an assembly machine configured to assemble the target assembly based on the assembly sequence of the target assembly.

### CROSS-REFERENCE TO RELATED APPLICATION

This application claims under 35 U.S.C. §119(a) the benefit of Korean Patent Application No. 10-2024-0133497, filed on October 2, 2024, the entire contents of which are incorporated herein by reference.

### BACKGROUND

### Technical Field

The present disclosure relates to a system and method for assembling a vehicle or other target assembly based on computer-aided design (CAD).

### Description of the Related Art

An assembly made up of multiple components, such as a vehicle, may be modeled using computer-aided design (CAD). By referring to the assembly modeled through CAD, the actual dimensions and locations of each component and the assembly relationship between the components may be known.

Conventionally, the structural assembly sequence for components has been manually verified using the cross-sectioning function in CAD. Particularly, such a verification process may be said to be essential for arranging components by process in the case of an assembly including many components, such as a vehicle. However, to verify the assembly sequence of hundreds of components assembled inline, many man-hours are needed every time when new vehicle model is developed, and rework may also be needed due to human error.

The above information disclosed in this Background sector is only for enhancement of understanding of the background of the present disclosure, and therefore it may contain information that does not form the prior art that is already known to one having ordinary skill in the art.

### SUMMARY

The present disclosure provides a system and method for assembling an assembly in which the assembly sequence of the assembly may be accurately and effectively determined based on computer-aided design (CAD).

The features of the present disclosure to achieve the object of the present disclosure as described above and to perform the characteristic functions of the present disclosure to be described later are as follows.

According to the present disclosure, a method for assembling a target assembly includes, wherein the method is performed by a computer, determining a disassembly sequence of the target assembly based on a CAD assembly that modeled the target assembly, determining an assembly sequence of the target assembly based on a comparison between the disassembly sequence and an assembly sequence of a pre-stored reference assembly, and, based on the assembly sequence of the target assembly, generating an operation path of an assembly machine configured to assemble the target assembly.

According to the present disclosure, a system for assembling a target assembly may include a memory configured to store a series of commands and a processor. The processor may be configured to, in response to executing the series of commands, determine a disassembly sequence of the target assembly based on a CAD assembly that modeled the target assembly, determine an assembly sequence of the target assembly based on a comparison between the disassembly sequence and an assembly sequence of a pre-stored reference assembly, and, based on the assembly sequence of the target assembly, generate an operation path of an assembly machine configured to assemble the target assembly.

According to one aspect of the present disclosure, a method for assembling a target assembly includes: determining, by a processor, a disassembly sequence of the target assembly based on a computer-aided design (CAD) assembly that models the target assembly; determining, by the processor, an assembly sequence of the target assembly, based on a comparison between the disassembly sequence and an assembly sequence of a pre-stored reference assembly; and generating, by the processor, an operation path of an assembly machine configured to assemble the target assembly, based on the assembly sequence of the target assembly.

For example, the target assembly may be a vehicle.

According to another aspect of the present disclosure, a system for assembling a target assembly includes: a memory configured to store a series of commands; and a processor configured to, in response to executing the series of commands: determine a disassembly sequence of the target assembly based on a CAD assembly that models the target assembly; determine an assembly sequence of the target assembly, based on a comparison between the disassembly sequence and an assembly sequence of a pre-stored reference assembly; and generate an operation path of an assembly machine configured to assemble the target assembly, based on the assembly sequence of the target assembly.

According to a further aspect of the present disclosure, a non-transitory computer readable medium containing program instructions executed by a processor includes: program instructions that determine a disassembly sequence of a target assembly based on a computer-aided design (CAD) assembly that models the target assembly; program instructions that determine an assembly sequence of the target assembly, based on a comparison between the disassembly sequence and an assembly sequence of a pre-stored reference assembly; and program instructions that generate an operation path of an assembly machine configured to assemble the target assembly, based on the assembly sequence of the target assembly.

Other aspects and preferred embodiments of the present disclosure are discussed infra.

### BRIEF DESCRIPTION OF THE DRAWINGS

The above and other features of the present disclosure will now be described in detail with reference to certain embodiments thereof shown in the accompanying drawings which are given herein below by way of illustration only, and thus are not limitative of the present disclosure, and wherein:

FIG. 1 is a diagram of a system for assembling an assembly according to an embodiment of the present disclosure;

FIG. 2A is a flowchart of determining an assembly sequence by a system for assembling an assembly according to an embodiment of the present disclosure;

FIG. 2B is a diagram of a sequence determination tool of a system for assembling an assembly according to an embodiment of the present disclosure;

FIGS. 3A through 3D illustrate specific examples of the operation process of a disassembly sequence generator of a sequence determination tool according to an embodiment of the present disclosure;

FIGS. 4A and 4B illustrate the sectors set by a sequence determination tool according to an embodiment of the present disclosure;

FIG. 5 shows a level tree generated by a level tree generator of a sequence determination tool according to an embodiment of the present disclosure;

FIGS. 6A, 6B, and 6C show a process of deriving an assembly sequence by an assembly sequence generator of a sequence determination tool according to an embodiment of the present disclosure;

FIGS. 7 and 8 explain a method of considering a component belonging to multiple sectors;

FIG. 9 is an operation flowchart of a disassembly sequence generator of a sequence determination tool according to an embodiment of the present disclosure;

FIG. 10 is an operation flowchart of a level tree generator of a sequence determination tool according to an embodiment of the present disclosure; and

FIG. 11 is an operation flowchart of an assembly sequence generator of a sequence determination tool according to an embodiment of the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

It is understood that the term "vehicle" or "vehicular" or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms "a," "an" and "the" are intended to include the plural forms as well, unless the context clearly indicates otherwise. It will be further understood that the terms "comprises" and/or "comprising," when used in this specification, specify the presence of stated features, integers, steps, operations, elements, and/or components, but do not preclude the presence or addition of one or more other features, integers, steps, operations, elements, components, and/or groups thereof. As used herein, the term "and/or" includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between”, “adjacent” versus “directly adjacent”, etc.).

Throughout the specification, like reference numerals indicate like components. The terminology used herein is for the purpose of illustrating embodiments and is not intended to limit the present disclosure. In this specification, the singular form includes the plural sense, unless specified otherwise.

Hereinafter, the present disclosure is described in detail with reference to the accompanying drawings.

As described above, conventionally, the cross-sectioning function in computer aided design (CAD) has been used to determine the assembly sequence of a vehicle. Specifically, a CAD software was executed to activate the data of a target vehicle model. From the data of the target vehicle model, a cross-section was set for a target portion so as to determine the assembly structure of the components. The assembly sequence for the components was determined by observing the set cross-section, and each cross-sections were observed to determine the assembly sequence for the components.

The conventional method needed excessive preprocessing labor time to specify the location of the components and to deactivate irrelevant components in order to utilize the cross-sectioning function. Moreover, the dependency between the components might be differently determined depending on the cross-sectional directions, and a human error might have occurred because the method was performed by a worker.

For this reason, the present disclosure provides a system and method for assembling an assembly capable of, by solving the aforementioned problems, effectively determining the assembly sequence of the assembly, such as a vehicle, and efficiently assembling the assembly based on the determined assembly sequence.

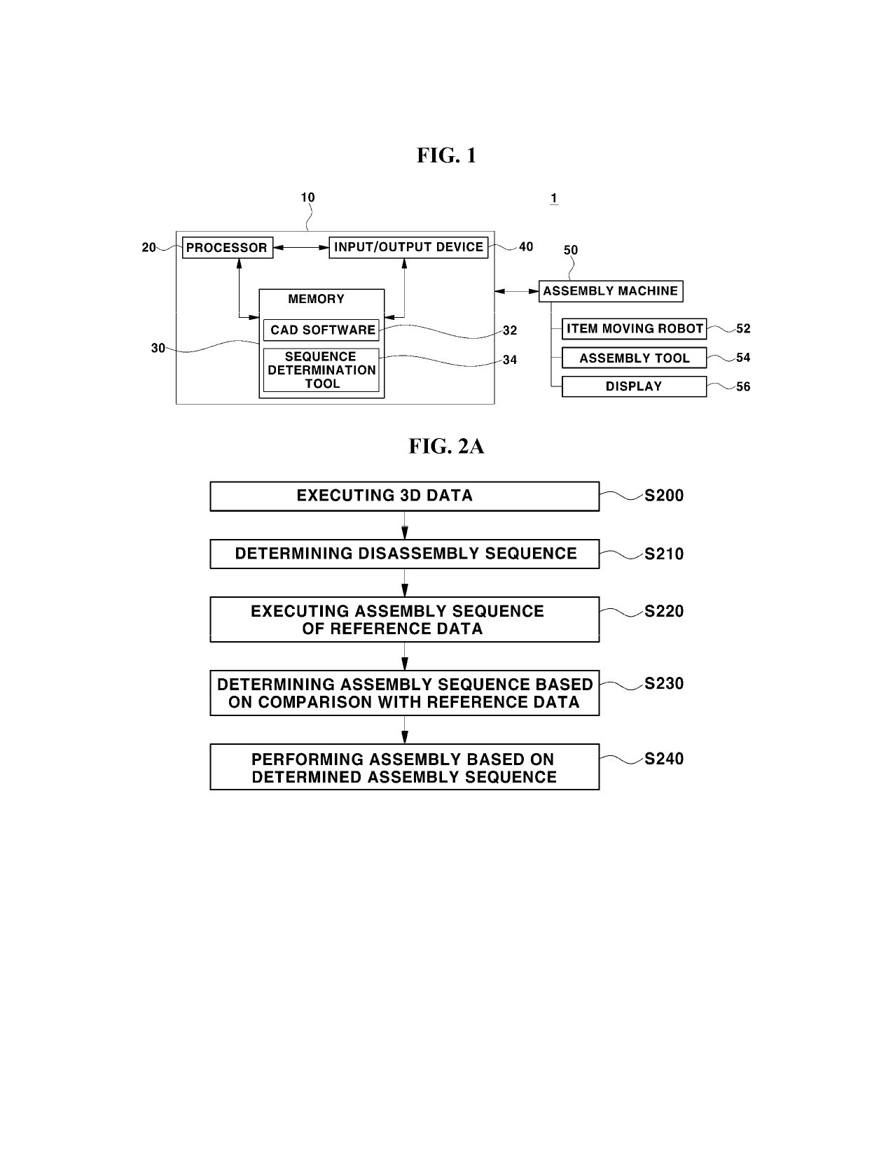

As shown in FIG. 1, a system 1 for assembling an assembly according to the present disclosure may include a computer 10 and an assembly machine 50. The computer 10 is configured to operate in conjunction with the assembly machine 50 so that the assembly is assembled by the assembly machine 50.

The computer 10 includes a processor 20 and a memory 30. The processor 20, which is a hardware, may execute computer-readable codes or a series of commands stored in the memory 30, and may process data. As a non-limiting example, the processor 20 may include a central processing unit, a graphics processing unit, a multi-core processor, a multiprocessor, an application-specific integrated circuit (ASIC), or a field programmable gate array (FPGA).

The memory 30 may store data, codes, or a series of commands executable by the processor 20. According to an embodiment of the present disclosure, the memory 30 may include a CAD software 32 and a sequence determination tool 34 configured to determine the assembly sequence of the assembly. Moreover, the memory 30 may store a CAD assembly in which an actual assembly is modeled by any CAD software.

Furthermore, the memory 30 may store data of a reference assembly. The reference assembly may be an assembly of the same type as an assembly whose assembly sequence is to be determined (hereinafter, “target assembly”) but may also be an assembly whose assembly sequence has been already established. Specifically, when the target assembly is a vehicle, the reference assembly may be a vehicle that is different from the target assembly only in the model number or model year, and data including the assembly sequence of the reference assembly may be stored in the memory 30.

The memory 30 may be a volatile memory or a non-volatile memory. As a non-limiting example, a volatile memory may include a dynamic random access memory (DRAM) or a static random access memory (SRAM). As another non-limiting example, a non-volatile memory may include an electrically erasable programmable read-only memory (EEPROM), a flash memory, a magnetic RAM (MRAM), a CD-ROM or a DVD-ROM.

Moreover, the computer 10 may include an input/output device 40. The input/output device 40 may include, but not limited to, a keyboard, a mouse, or a monitor, as an interface with the computer 10.

The computer 10 is configured to communicate with the assembly machine 50. The computer 10 may transmit results calculated according to a series of commands to the assembly machine 50. In one embodiment, the computer 10 may provide the assembly machine 50 with the operation path of the assembly machine 50, obtained based on the assembly sequence determined according to the sequence determination tool 34, which is a set of commands. The assembly machine 50 may assemble the assembly based on the operation path.

In one embodiment, the assembly may be a vehicle. The vehicle is an assembly made up of a plurality of components. In one example, the vehicle may be generally manufactured through four processes. The four processes may include a press process, a body process, a painting process, and an assembly process. In the press process, a steel sheet is formed into each portion of the vehicle. For example, a door, a hood, etc., of the vehicle may be formed into a desired shape through the press process. In the body process, components formed through the press process may be welded to form a vehicle body. In the painting process, the vehicle body formed by welding may be coated by chemicals and painted. Finally, in the assembly process, functional components may be assembled to the painted body. Here, the functional component may include a chassis, an interior component, an exterior component, an electrical component, and a moving component.

Moreover, the vehicle may include a body component and an assembly part. The body component may be generally called a panel component. For example, the body component may include a door panel, a hood panel, a floor panel, etc. The assembly part may be any component assembled to the vehicle body. As a non-limiting example, the assembly part may include a chassis module, a battery, a crash pad, a seat, etc.

Particularly, the computer 10 may determine the assembly sequence of the assembly part in the assembly process for the vehicle, and the assembly machine 50 may perform the assembly of the assembly part according to the operation path determined based on the determined assembly sequence. In the present disclosure, the assembly machine 50 may include not only the machine configured to assemble the components of the actual assembly but also the machine configured to supply components to each assembly location in the inline assembly process or the system configured to support assembling of each component.

In one embodiment, the assembly machine 50 may include an item moving robot 52 or an automated guided vehicle. The item moving robot 52 may deliver each component to an assembly location according to the assembly sequence determined by the computer 10. In some embodiments, based on the determined assembly sequence, the computer 10 may generate an operation path including a sequence for loading the components on the item moving robot 52 and a movement path of the item moving robot 52 for supplying the components to the assembly location and may allow the item moving robot 52 to operate according to the generated operation path. In some embodiments, the computer 10 may generate an operation path including a sequence for loading the components on the item moving robot 52 and a movement path of the item moving robot 52 determined in consideration of the sequence for loading the components, based on the size of the component and the determined assembly sequence. Moreover, the item moving robot 52 may operate according to the generated operation path. According to the present disclosure, the sequence for loading the components on the item moving robot 52 or the movement path of the item moving robot 52 is determined based on an exact assembly sequence, improving the efficiency in assembling the components.

In one embodiment, the assembly machine 50 may be an assembly tool 54 for a component. The computer 10 may adjust the fastening torque of the assembly tool 54 according to a determined assembly sequence. Specifically, the computer 10 may set the torque of the assembly tool 54 to a fastening torque suitable for each component when a component to be assembled reaches its assembly turn based on the determined assembly sequence. One or more assembly tools 54 may be used in one process. In some embodiments, when a plurality of assembly tools 54 is used, the computer 10 may sequentially activate the assembly tools 54 according to the determined assembly sequence.

In one embodiment, the assembly machine 50 may be a display 56 configured to communicate with the computer 10. The display 56 may be placed on an actual assembly line. As a non-limiting example, the display 56 may include a monitor. The computer 10 may transmit a determined assembly sequence to the display 56, and the display 56 may display the received determined assembly sequence. In one embodiment, the display 56 may be one component of an electronic work instruction system in a smart factory. For example, the computer 10 may switch the screen of the display 56 according to the determined assembly sequence. Images displayed on the screen may be switched according to the determined assembly sequence. In one example, whether to display the overall determined assembly sequence on the display 56 may be determined by a user.

According to the present disclosure, the assembly system 1 may determine the assembly sequence of the assembly, such as a vehicle. Specifically, the processor 20 may determine the assembly sequence of the assembly by executing the CAD software 32 stored in the memory 30 and the sequence determination tool 34 configured to determine the assembly sequence of the assembly. Hereinafter, how the assembly sequence is generated by the assembly system 1 is described in detail by taking an example of assembling an assembly part to a vehicle.

An assembly may be modeled through the CAD software 32. A CAD assembly representing an actual assembly may be generated and executed by the CAD software 32.

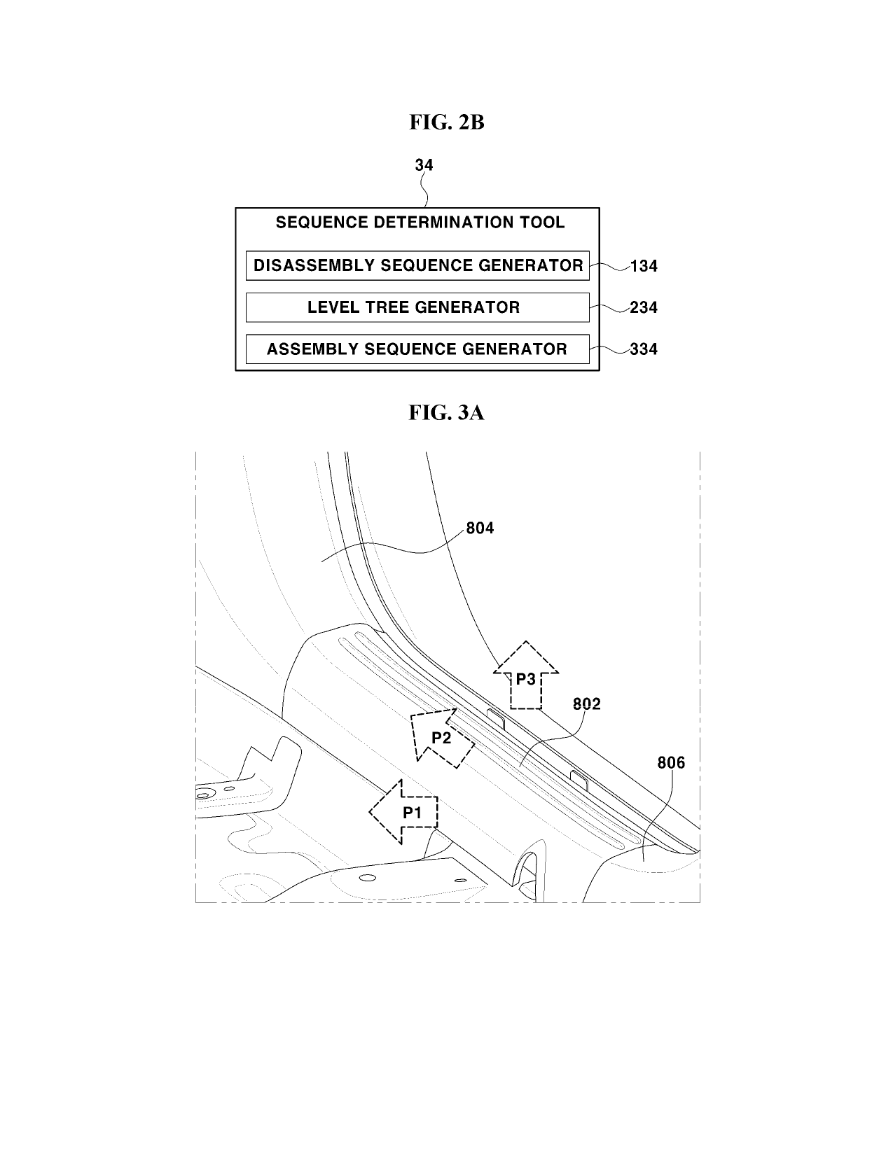

As shown in FIG. 2A, through a series of operations of the sequence determination tool 34, the assembly system 1 may determine the assembly sequence of an assembly. Differently put, the assembly system 1 may determine the assembly sequence of an assembly part for a vehicle. As mentioned above, the assembly whose assembly sequence is to be determined is referred to as a target assembly.

Specifically, when the sequence determination tool 34 is executed by the processor 20, the processor 20 may execute a CAD assembly that models a target assembly through CAD at operation S200 and may determine the disassembly sequence of the target assembly based on the data of the executed CAD assembly at operation S210. Thereafter, the processor 20 may execute the assembly sequence of the reference assembly pre-stored in the memory 30 (“reference data”) at operation S220 and may determine the assembly sequence of the target assembly by comparing the determined disassembly sequence with the reference data at operation S230. The determined assembly sequence of the target assembly may be used in assembling the target assembly at operation S240.

In order to determine the assembly sequence of the target assembly as described above, the sequence determination tool 34 according to an embodiment of the present disclosure may include, as shown in FIG. 2B, a disassembly sequence generator 134, a level tree generator 234, and an assembly sequence generator 334.

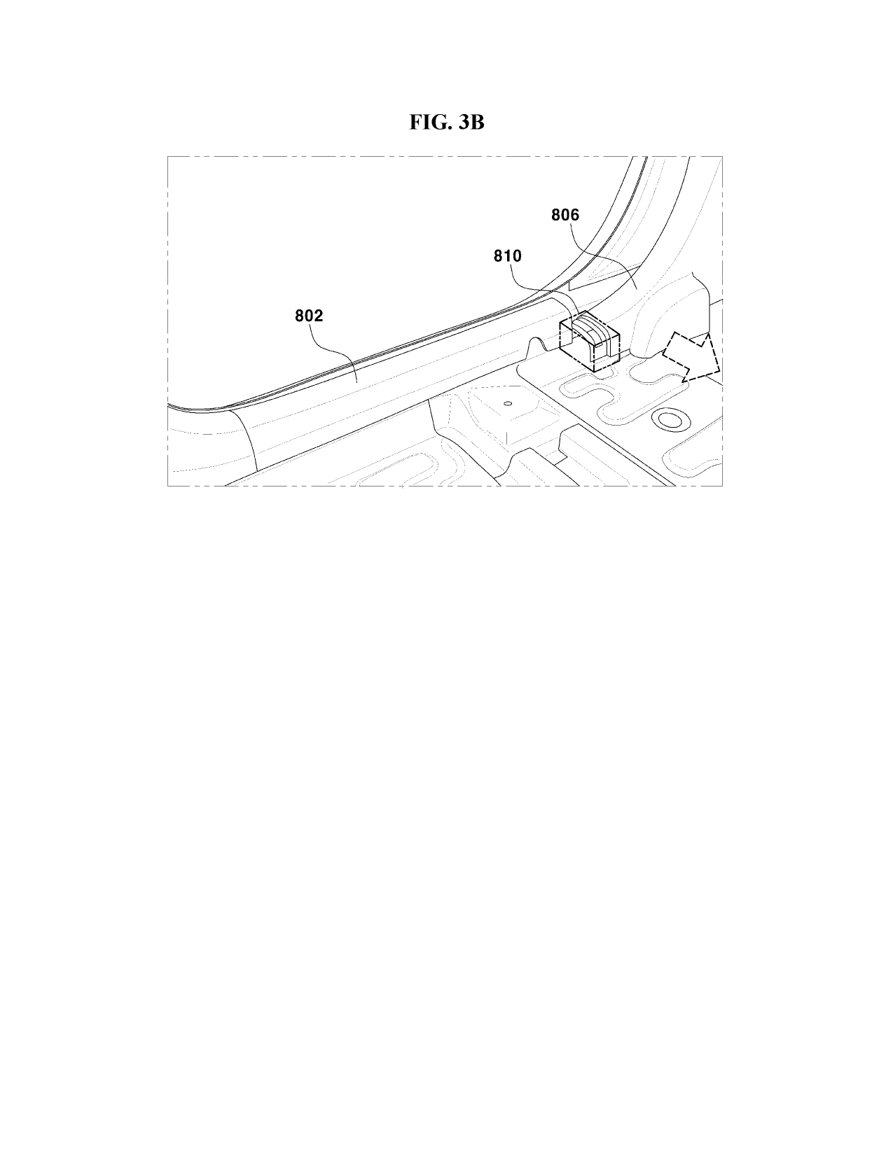

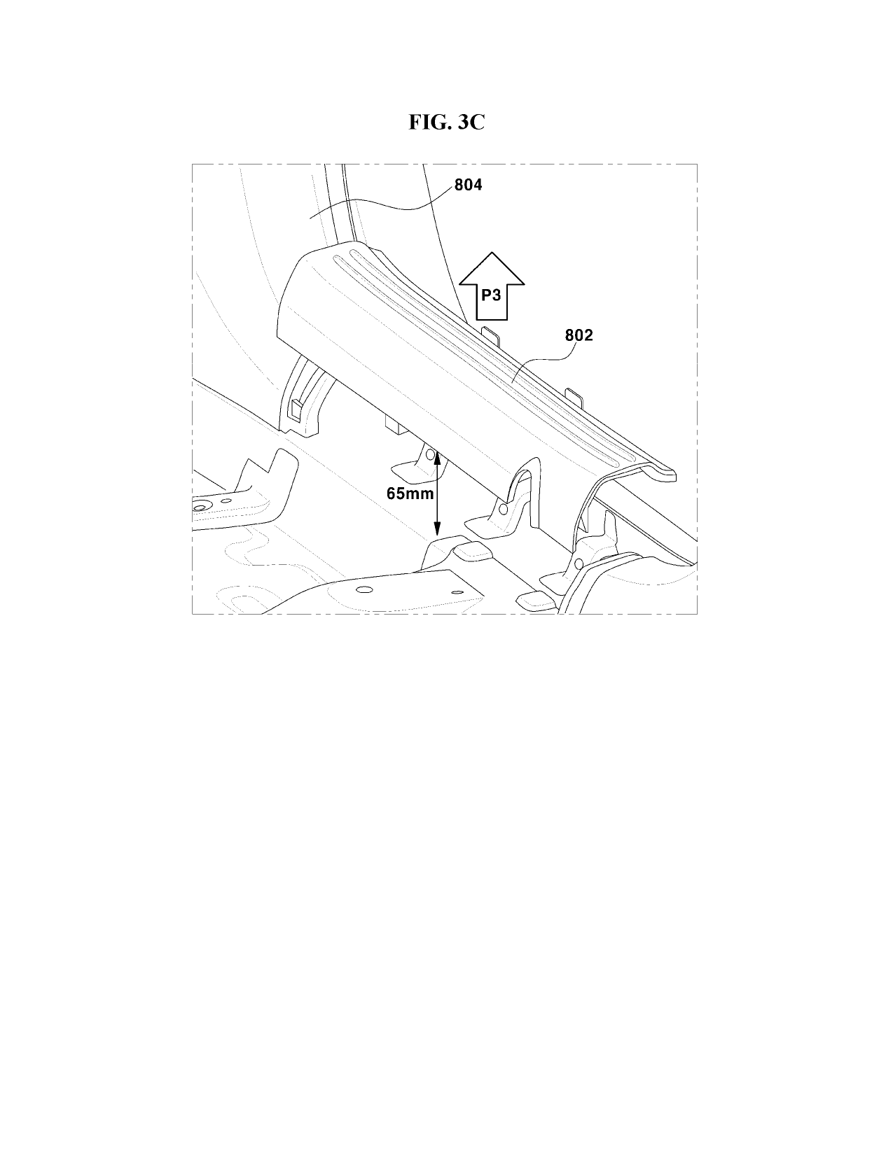

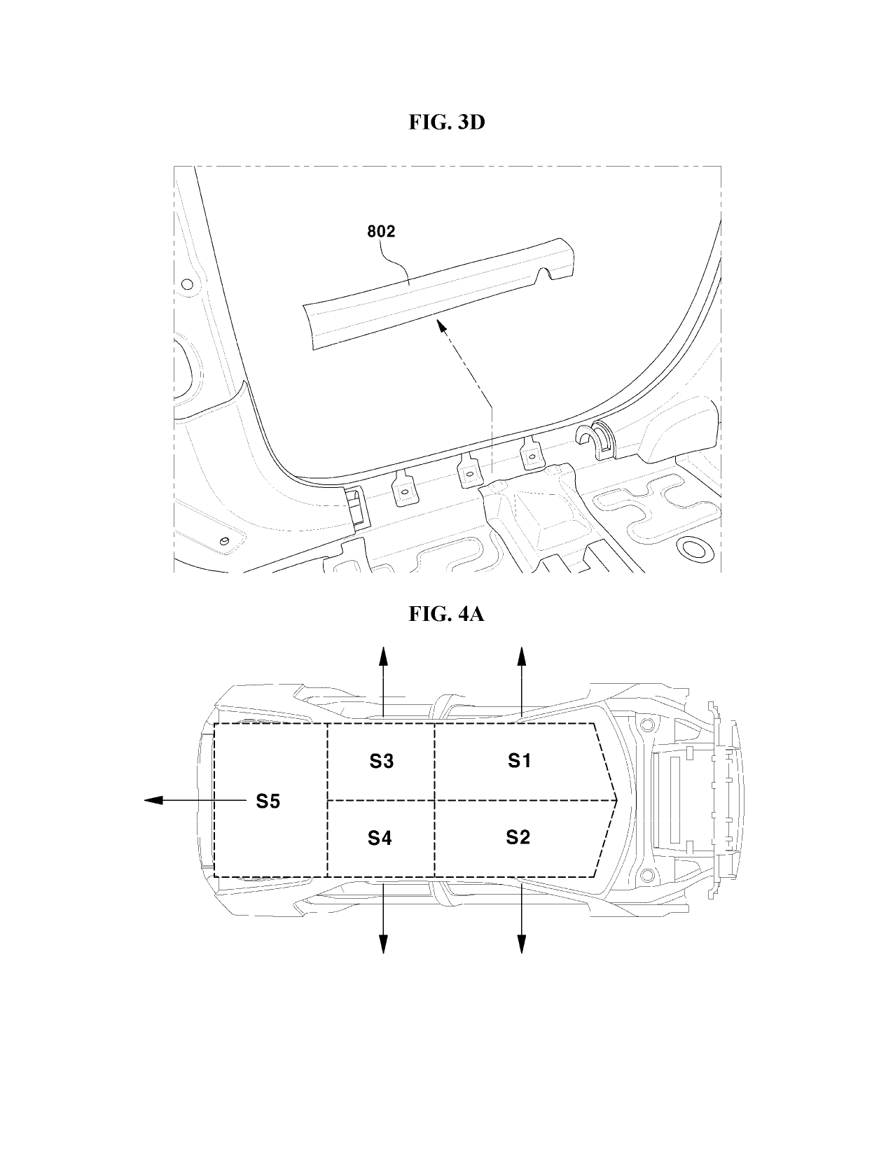

The disassembly sequence generator 134 is configured to determine the disassembly sequence of the CAD assembly as in the operation S210. The disassembly sequence generator 134 generates all disassembly paths where all components for the CAD assembly can be disassembled. FIG. 3A illustrates a lower portion of a front door of the vehicle where the lower portion includes a front door scuff trim 802, a cowl side trim 804, and a B-pillar lower trim 806. FIG. 3A illustrates an example of disassembling the front door scuff trim 802. The front door scuff trim 802 may be disassembled in a direction P1, a direction P2 or a direction P3 as illustrated in the drawing. However, FIG. 3A illustrates only some of the directions in which the front door scuff trim 802 can be disassembled, and the disassembly sequence generator 134 is configured to generate all directions in which the front door scuff trim 802 can escape. Here, escape routes may be predetermined for each sector described below. Differently put, the disassembly sequence generator 134 may generate all disassembly paths in which the mounting position of each component can be connected to a predetermined final destination through an escape route in each sector. Here, all components of the CAD assembly may be put in an active state, and the doors, hood, and tailgate of the vehicle may be put in an open state.

Moreover, as illustrated in FIG. 3B, the disassembly sequence generator 134 may generate a portion or volume of a component that interfere with another component for all disassembly paths. For example, the disassembly sequence generator 134 may generate a collision volume 810 when an interference occurs in the relation between the front door scuff trim 802 and the B-pillar lower trim 806 when disassembling the front door scuff trim 802. The collision volume 810 is a shared volume between components that is generated when a component to be disassembled moves in a specific path.

Moreover, as illustrated in FIG. 3C, the disassembly sequence generator 134 sets an optimal disassembly path for each component in which a component may be disassembled with a shortest distance, among the paths not including a collision volume. Here, the shortest distance may be a shortest disassembly length for a component having two or more paths not including a collision volume. In the illustrated example, among the multiple disassembly paths, the front door scuff trim 802 may be disassembled in the direction P3, which does not include a collision volume and is an optimal disassembly path.

As illustrated in FIG. 3D, the disassembly sequence generator 134 may sequentially disassemble components starting from a component not having a collision portion and store the disassembly number of the component. The disassembly number of each component is designated as a level LV. Here, the level LV is a natural number greater than 0.

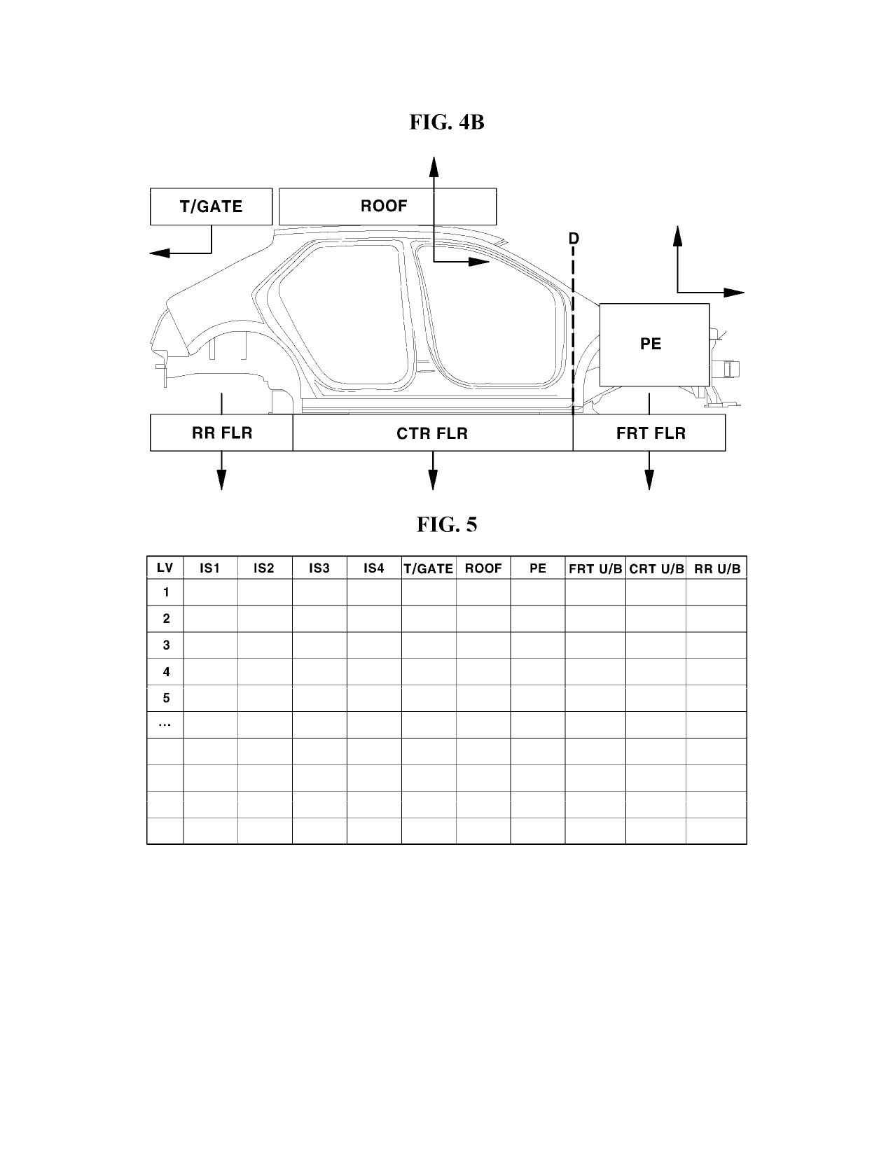

Moreover, the disassembly sequence generator 134 may identify the sectors where each disassembled component is located and store the identified sectors for each component, along with the disassembly sequence for each component. For example, as illustrated in FIG. 4A, the sectors may be set to be divided into S1, S2, S3, S4, and S5 in the plan view for the vehicle. Furthermore, as illustrated in FIG. 4B, the sectors may be set to be divided into a tailgate sector (T/GATE), a roof sector (ROOF), a power electronics sector (PE), a front floor sector (FRT FLR), a center floor sector (CTR FLR), and a rear floor sector (RR FLR) in the side view for the vehicle. In the illustrated example, the sectors may be set to be eleven sectors. The disassembly sequence generator 134 may determine which sector a disassembled component belongs to based on the coordinates of the disassembled component. This process may be repeated until all the assembly parts are disassembled.

As shown in FIG. 5, the level tree generator 234 is configured to generate the level LV indicating a disassembly number and a level tree indicating a sector, for each component. In the CAD assembly, each component may be distinguished by an identifier configured to identify each component. In one example, the identifier may be the component number and/or component name of a component. When a level tree is generated, levels LV and sectors for all components of the target assembly may be known.

The assembly sequence generator 334 may generate an assembly sequence for the target assembly based on the level tree generated by the level tree generator 234 and the reference data of the reference assembly.

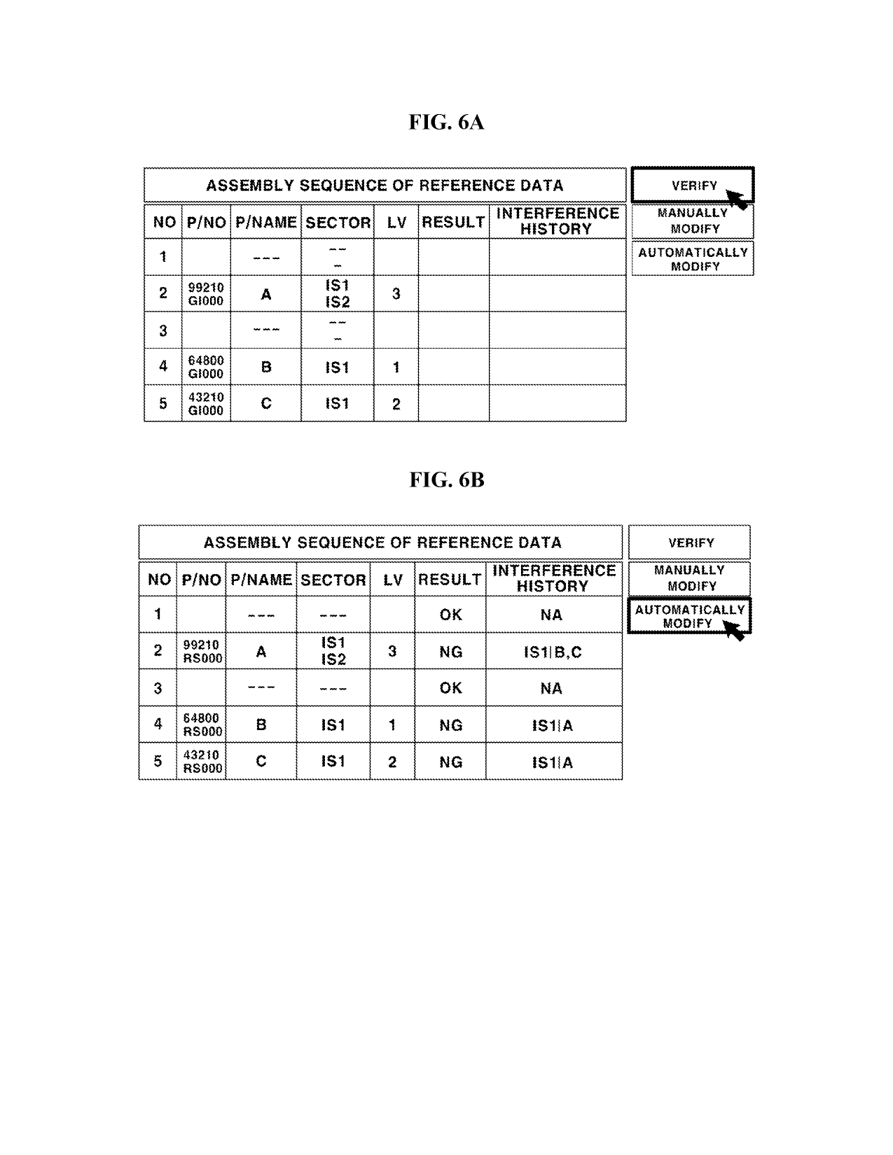

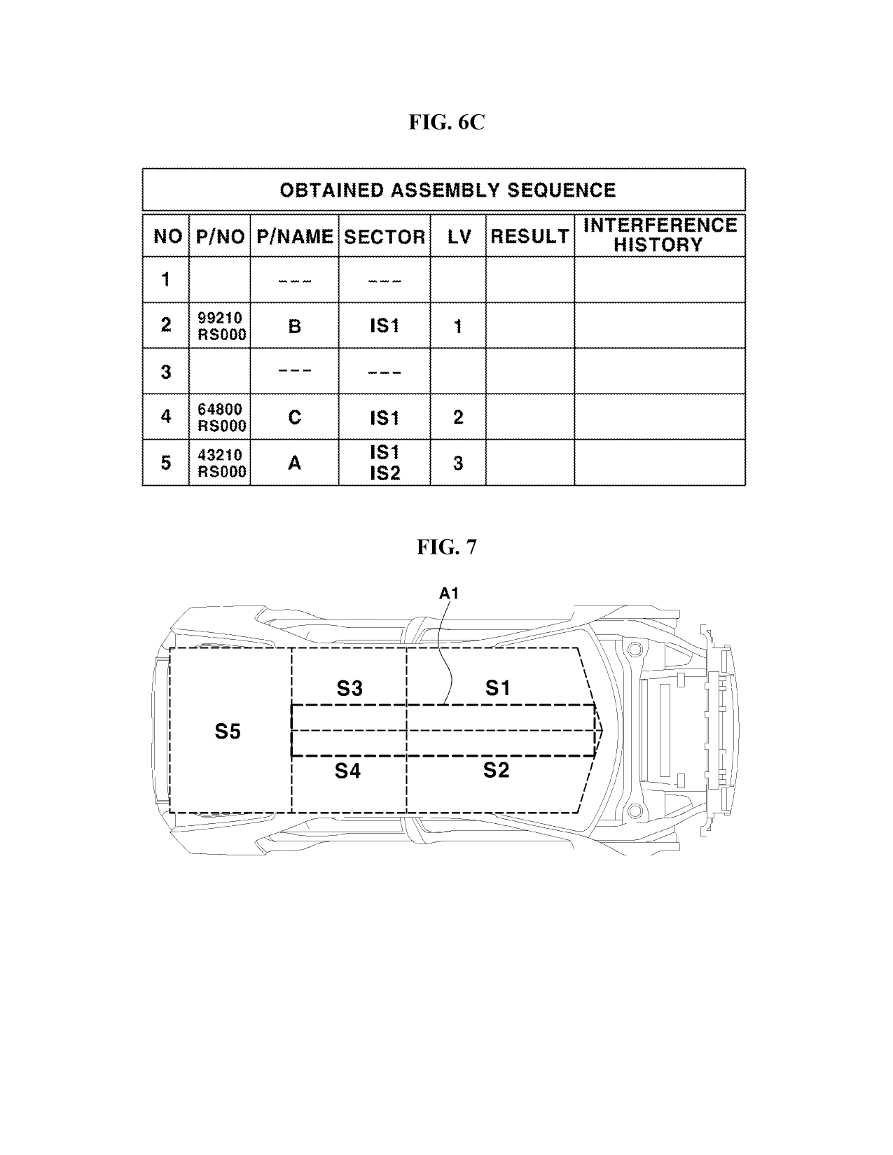

Referring to FIGS. 6A, 6B, and 6C, the assembly sequence generator 334 executes reference data. In the reference data, each component of the reference assembly is arranged in assembly sequence, and identifiers of each component are included in the reference data. The assembly sequence generator 334 inputs a previously obtained level LV for a component that is also included in the target assembly among the components included in the reference data. Whether the component in the reference data and the component of the target assembly are the same may be determined by the identifier described above. When the levels LV inputted in the reference data are not arranged in an ascending order, an error NG may be displayed as shown in the table as in FIG. 6B. For the data indicated with the error NG, the assembly sequence generator 334 may rearrange each row so that the levels LV may be arranged in an ascending order. Accordingly, the assembly sequence of the target assembly may be obtained (FIG. 6C).

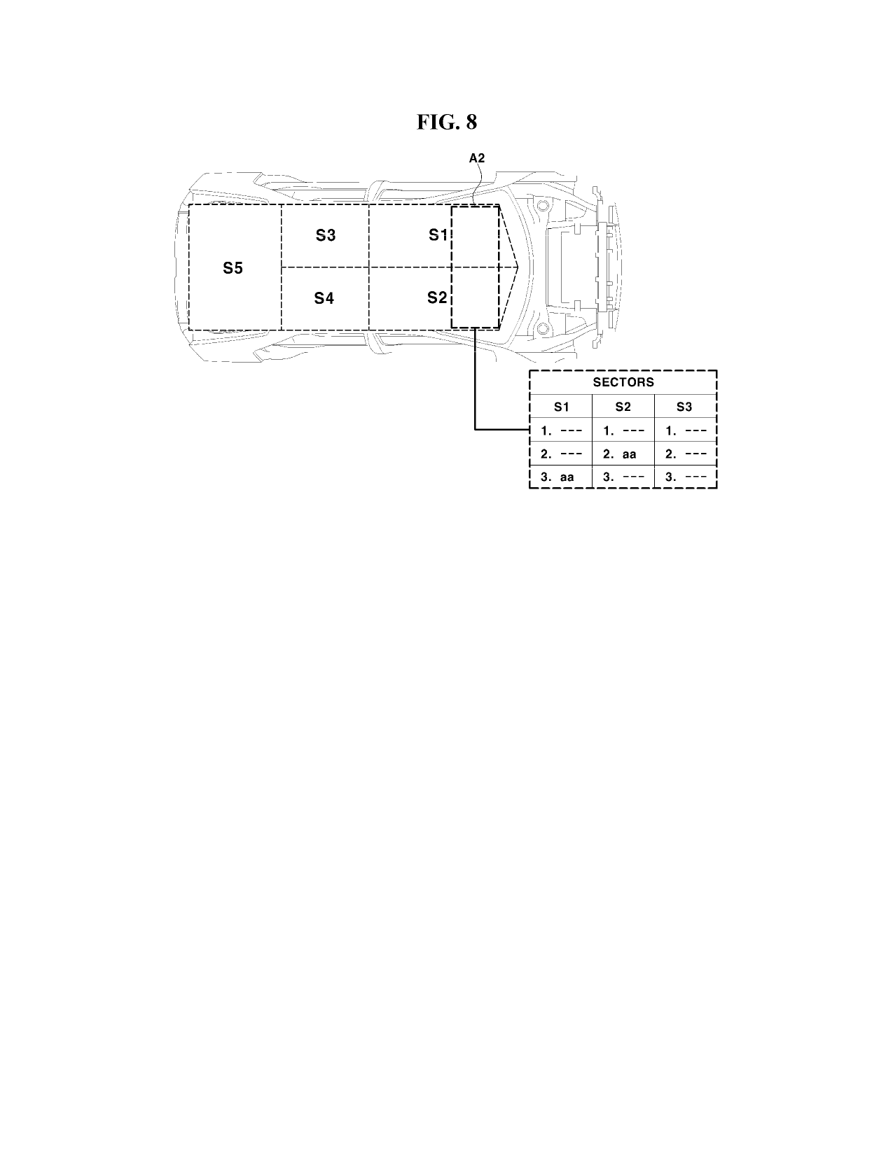

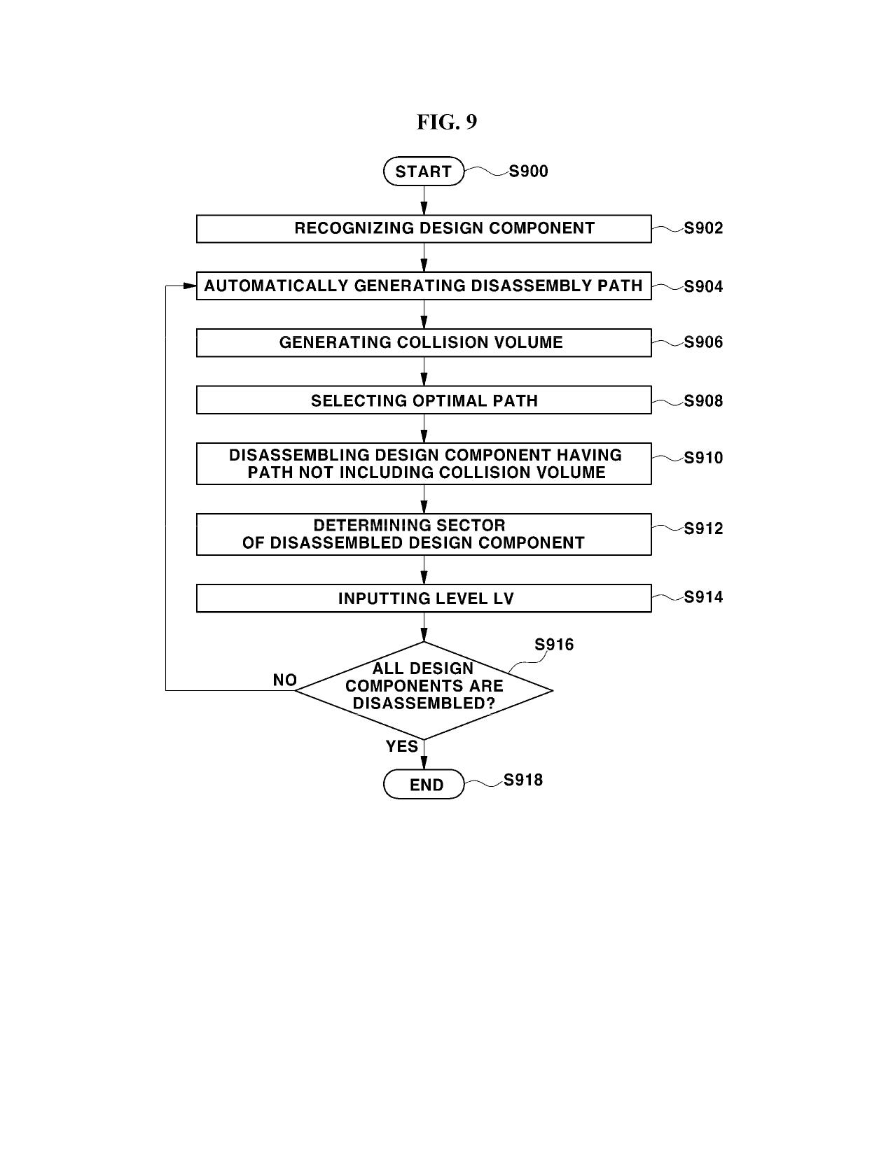

In the above, it is described that a component belongs to only one of the sectors. However, there may be a component that belongs to all the sectors S1, S2, S3, and S4, as illustrated in FIG. 7. In one example, when setting the disassembly path of such a component, the path may be selected in an “or” condition and may also be manually designated. In other words, in the case of a component located in multiple sectors, the component may be selectively escaped in any one of the escape routes in each sector to which the component belongs. Selecting of an escape route may be determined by considering interference of components in the escape route and the shortest distance between the components. In another example, as shown in FIG. 8, the designation of such a component in the level tree may be recorded for each sector. Any component A2 belonging to both sectors S1 and S2 is recorded in both S1 and S2 in the level tree (indicated as “aa” in the illustrated example).

Based on the assembly sequence obtained through this process, an operation path of the assembly machine 50 may be generated, and the assembly machine 50 may operate in accordance with the operation path.

Hereinafter, referring to FIGS. 9 through 11, the operation of the sequence determination tool 34 for an assembly part of a vehicle is explained.

FIG. 9 shows a flowchart of generating a disassembly sequence by the disassembly sequence generator 134. Referring to FIG. 9, generation of a disassembly sequence of an assembly part is initiated at operation S900.

At operation S902, the computer 10 recognizes an assembly part in a CAD assembly of a target assembly. The computer 10 is configured to recognize the assembly part in the CAD assembly of the target assembly separately from the body component of the vehicle. Because the body component is unrelated to the assembly sequence of the assembly part, the body component is only considered when generating the disassembly path of the assembly part, and may not be considered when determining the dependency among components.

At operation S904, the computer 10 may automatically generate, for each assembly part, all possible paths where an assembly part can be disassembled according to the aforementioned logic where passing points are predetermined for each sector based on the coordinates.

At operation S906, the computer 10 may calculate collision volumes for each generated path.

At operation S908, the computer 10 may select a path with a shortest distance (i.e., an optimal path) from the paths not including a collision volume as a path for a corresponding assembly part. At operation S910, the computer 10 may disassemble the assembly part having the path not including a collision volume.

At operation S912, the computer 10 may determine the sector of the assembly part based on the coordinates of the disassembled assembly part. Then, at operation S914, the computer 10 designates levels LV starting from an assembly part that was disassembled first in the determined sector. For example, the level LV may be expressed as 1, 2, 3, …, n. For a component not belonging to only one sector, the level LV may be assigned redundantly on all sectors the component belongs to.

The computer 10 may determine whether all the assembly parts have been disassembled, at operation S916. This is because the collision volume by each component varies depending on the stage in which the assembly parts are disassembled. Therefore, the computer 10 may return to the operation S904 and perform the operations thereafter until all the assembly parts are disassembled.

When it is determined that all of the assembly parts has been disassembled, the computer 10 may terminate the operation of the disassembly sequence generator 134.

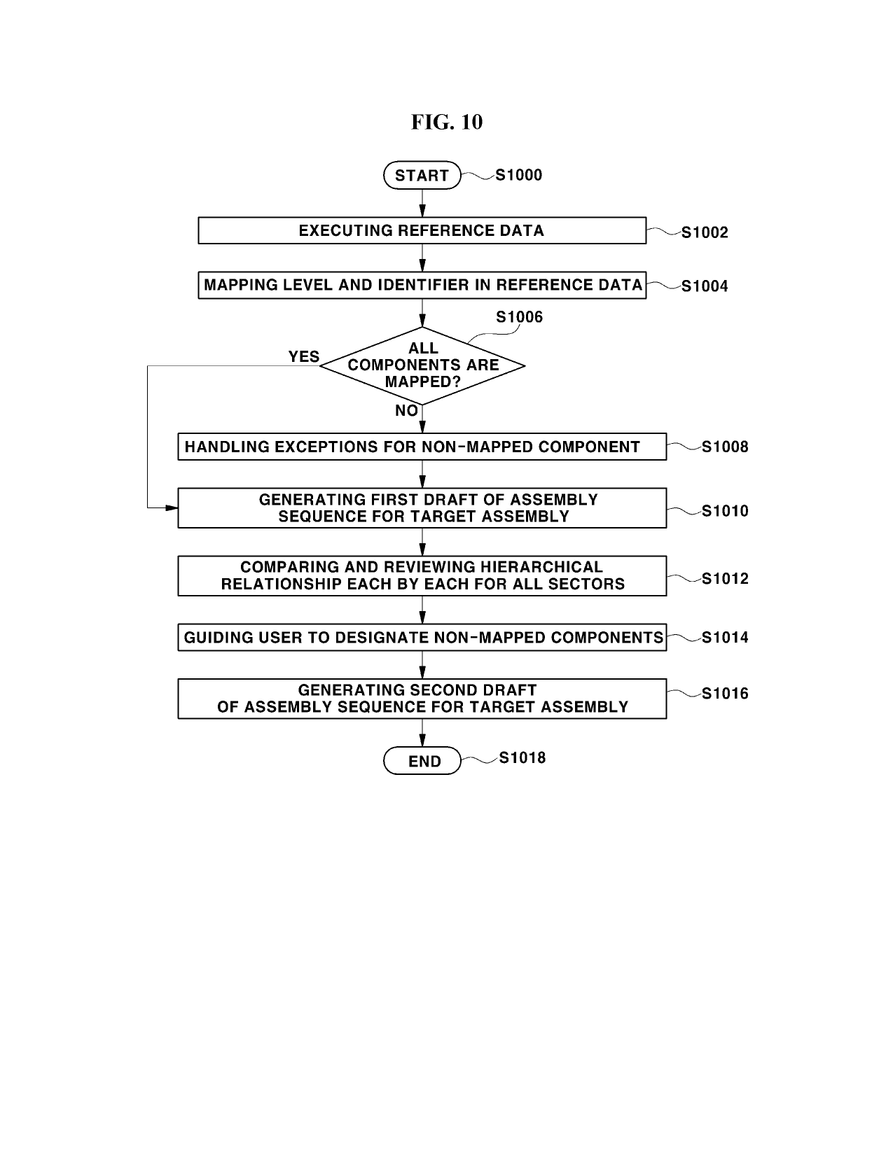

FIG. 10 shows the operation flowchart for the level tree generator 234.

At operation S1000, the operation of the level tree generator 234 begins. When the level tree generator 234 starts to operate, the computer 10 may execute reference data including the assembly sequence of an existing vehicle, at operation S1002. When the entire assembly formation is changed only with the level tree based on the generated disassembly sequence, problems in logistics, worker training, etc,. may occur. For this reason, according to the present disclosure, reference data may be used as a reference. Moreover, the computer 10 may map level LV information, sectors and identifiers (e.g., component name, component number, etc.) obtained by the disassembly sequence generator 134 one-to-one with the reference data, at operation S1004.

At operation S1006, the computer 10 may determine whether all components are mapped. At operation S1008, the computer 10 may be configured to exclude components that cannot be mapped, such as newly added or deleted components compared to the reference data.

At operation S1010, the computer 10 may generate a first draft of the assembly sequence for assembly parts without the excluded components.

At operation S1012, the computer 10 may compare the hierarchical relationship each by each for all sectors. As in the aforementioned sectors, the sectors of the interior, exterior, roof, and underbody of the vehicle are each designated by the number from 1 to 11, and incorrect items are detected and reflected in the first draft.

At operation S1014, the computer 10 may guide the user to designate the non-mapped components excluded at the operation S1008, and the corresponding components may be handled by the user.

When handling of the non-mapped components is completed, the computer 10 generates a second draft of the assembly sequence for the modified target assembly at operation S1016 and terminates the operation of the level tree generator 234 at operation S1018.

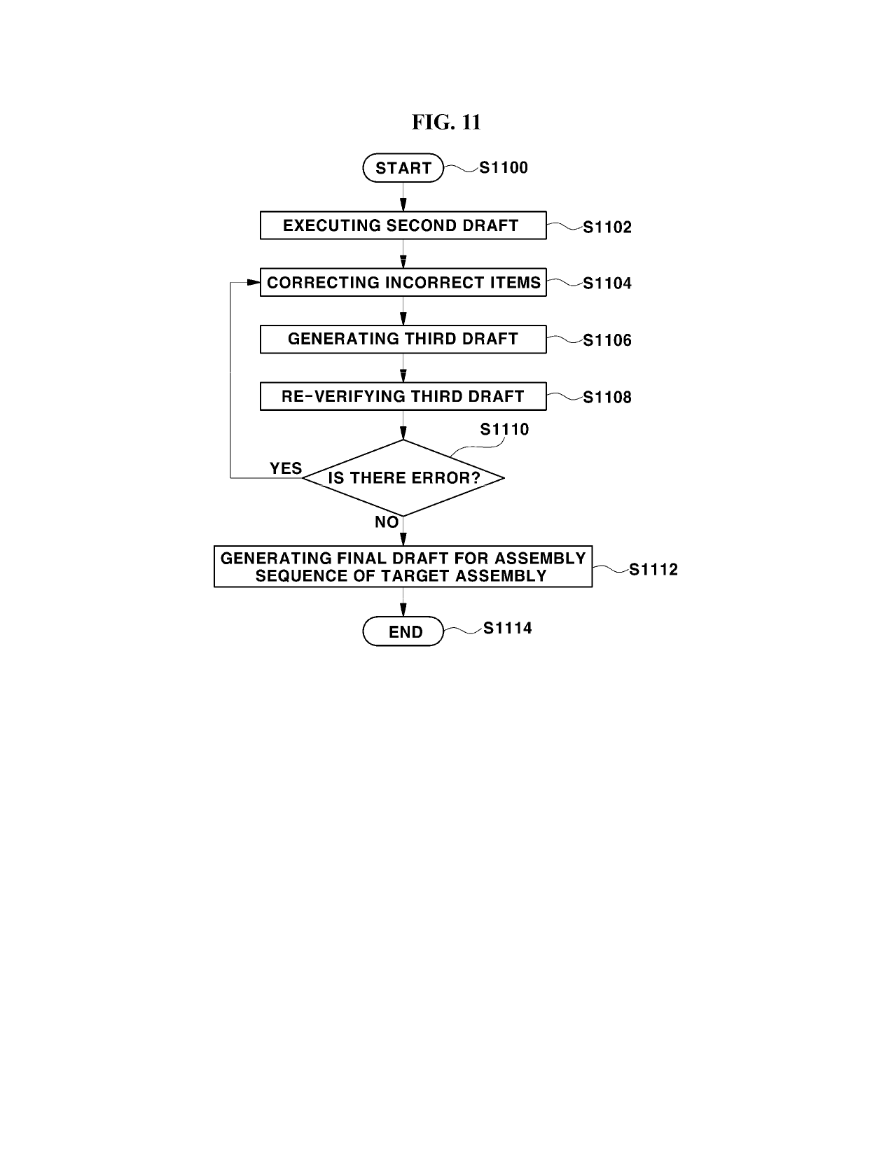

FIG. 11 shows the operation flowchart for the assembly sequence generator 334.

At operation S1100, the operation of the assembly sequence generator 334 begins. When the assembly sequence generator 334 starts to operate, the computer 10 may call up the second draft of the assembly sequence for the target assembly obtained by the operation in FIG. 10, at operation S1102.

At operation S1104, the computer 10 may correct, for all sectors, the incorrect items that are not displayed in an ascending order as in FIGS. 6A, 6B, and 6C in the second draft. In FIGS. 6A, 6B, and 6C, one row indicates one component, and the vertical arrangement of the rows may indicate the assembly sequence. Correcting incorrect items may mean changing the rows so that the levels LV are in an ascending order as in FIG. 6C.

At operation S1106, the computer 10 may generate a third draft of the assembly sequence for the target assembly in which the correction of the incorrect items has been reflected. At operation S1108, the computer 10 may go through a process of re-verifying the third draft. When a component whose row has been switched at operation S1104 belongs to multiple sectors, it may affect the order of components belonging to other sectors and placed between the switched rows, so a re-verification process may be performed.

At operation S1110, the computer 10 may determine whether there is an error in the re-verification process. When there is no error, the computer 10 may generate the third draft as a final draft for the assembly sequence of the target assembly and the operation of the assembly sequence generator 334 may be terminated, at operations S1112 and S1114. When there is an error, the computer 10 may return to the operation S1104 to correct the incorrect items and re-execute the operations thereafter.

According to some forms of the present disclosure, the assembly method performed by the assembly system may also be implemented in the form of a recording medium including computer-executable instructions, such as a program module executed by a computer. A computer-readable medium may be any available medium that may be accessed by a computer, and may include both volatile and nonvolatile media and removable and non-removable media. Moreover, the computer-readable medium may include all computer storage media. A computer storage medium includes volatile and nonvolatile, removable and non-removable media implemented in any method or technology for storing information, such as computer-readable instructions, data structures, program modules or other data.

In the assembly process for a vehicle, hundreds of components and small items are assembled. In order to allocate components and tasks to each step in the assembly process, determination of the structural dependency among the components, i.e., the assembly sequence, must be done as a top priority. The conventional method of determining the assembly sequence is complicated because it needs to cut the components to the cross-section one by one in CAD software to check the dependency between the components, which entails excessive labor time. Hundreds of components are managed by being divided into at least several systems (e.g., interior, exterior, moving, chassis, and electric systems), and human errors often occur because there are gaps between reviews each done by different system managers.

The system for assembling an assembly according to the present disclosure is configured to extract and move only items whose assembly sequence is structurally different while basically following the existing formation of vehicle model. In this process, human labor and determination made by a person are eliminated through computer calculations, reducing many man-hours needed in preprocessing and verification and reducing human errors, thereby achieving early-stage stabilization of the assembly line.

As is apparent from the above description, the present disclosure provides the following effects.

According to the present disclosure, provided are a system and method for assembling an assembly in which the assembly sequence of the assembly may be accurately and effectively determined based on CAD.

Effects of the present disclosure are not limited to what has been described above, and other effects not mentioned herein will be clearly recognized by those skilled in the art based on the above description.

It will be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A method for assembling a target assembly, the method comprising:
determining, by a processor, a disassembly sequence of the target assembly based on a computer-aided design (CAD) assembly that models the target assembly;
determining, by the processor, an assembly sequence of the target assembly, based on a comparison between the disassembly sequence and an assembly sequence of a pre-stored reference assembly; and
generating, by the processor, an operation path of an assembly machine configured to assemble the target assembly, based on the assembly sequence of the target assembly.

2. The method of claim 1, wherein determining the disassembly sequence comprises:
generating all possible disassembly paths for disassembling all components of the target assembly;
determining whether there is a collision path in which a component collides with another component in the all possible disassembly paths;
based on the determination on the collision path, starting to disassemble from a component that does not have the collision path in the all possible disassembly paths; and
storing level numbers in disassembly order of the components.

3. The method of claim 2, wherein starting to disassemble from a component that does not have a collision path comprises:
in response to a component including a plurality of non-collision paths, selecting a path having a shortest distance among the plurality of non-collision paths as a disassembly path; and
disassembling the component based on the selected disassembly path.

4. The method of claim 1, wherein determining the assembly sequence of the target assembly comprises:
retrieving an assembly sequence of the reference assembly, wherein the assembly sequence of the reference assembly comprises an identifier and an assembly number for each component of the reference assembly;
determining a component of the reference assembly having a same identifier as a component of the target assembly in the components of the reference assembly;
assigning a level number of the component of the target assembly to the identified component of the reference assembly;
based on the level number assigned to the reference assembly, arranging an assembly sequence of the reference assembly in an ascending order of the level numbers; and
setting the arranged assembly sequence of the reference assembly as an assembly sequence of the target assembly.

5. The method of claim 1, wherein generating the operation path comprises, based on the assembly sequence of the target assembly, generating a movement path of the assembly machine moving to an assembly location of each component.

6. The method of claim 5, wherein the assembly machine is an item moving robot.

7. The method of claim 1, wherein generating the operation path comprises, based on the assembly sequence of the target assembly, sequentially activating an assembly tool configured to assemble each component.

8. The method of claim 1, wherein the assembly sequence of the target assembly is an assembly sequence of an assembly part of a vehicle.

9. The method of claim 1, wherein the method is a computer-implemented method carried out by the processor and a memory configured to store a series of commands executable by the processor.

10. The method of claim 9, wherein the memory is configured to store the CAD assembly that models the target assembly.

11. The method of claim 9, wherein the memory is configured to store the reference assembly.

12. The method of claim 1, wherein the target assembly is a vehicle.

13. A system for assembling a target assembly, the system comprising:
a memory configured to store a series of commands; and
a processor configured to, in response to executing the series of commands:
determine a disassembly sequence of the target assembly based on a CAD assembly that models the target assembly;
determine an assembly sequence of the target assembly, based on a comparison between the disassembly sequence and an assembly sequence of a pre-stored reference assembly; and
generate an operation path of an assembly machine configured to assemble the target assembly, based on the assembly sequence of the target assembly.

14. The system of claim 13, wherein the processor is further configured to:
generate all possible disassembly paths for disassembling all components of the target assembly;
determine whether there is a collision path in which a component collides with another component in the all possible disassembly paths;
based on the determination on the collision path, start to disassemble from a component that does not have the collision path in the all possible disassembly paths; and
store level numbers in disassembly order of the components.

15. The system of claim 14, wherein the processor is further configured to:
in response to a component including a plurality of non-collision paths, select a path having a shortest distance among the plurality of non-collision paths as a disassembly path; and
disassemble the component based on the selected disassembly path.

16. The system of claim 13, wherein the processor is further configured to:
retrieve an assembly sequence of the reference assembly, wherein the assembly sequence of the reference assembly comprises an identifier and an assembly number for each component of the reference assembly;
determine a component of the reference assembly having a same identifier as a component of the target assembly in the components of the reference assembly;
assign a level number of the component of the target assembly to the identified component of the reference assembly;
based on the level number assigned to the reference assembly, arrange an assembly sequence of the reference assembly in an ascending order of the level numbers; and
set the arranged assembly sequence of the reference assembly as an assembly sequence of the target assembly.

17. The system of claim 13, wherein the processor is further configured to, based on the assembly sequence of the target assembly, generate a movement path of the assembly machine moving to an assembly location of each component.

18. The system of claim 13, wherein the target assembly is a vehicle.

19. The system of claim 18, wherein a component assembled to the vehicle is an assembly part of the vehicle.

20. A non-transitory computer readable medium containing program instructions executed by a processor, the computer readable medium comprising:
program instructions that determine a disassembly sequence of a target assembly based on a computer-aided design (CAD) assembly that models the target assembly;
program instructions that determine an assembly sequence of the target assembly, based on a comparison between the disassembly sequence and an assembly sequence of a pre-stored reference assembly; and
program instructions that generate an operation path of an assembly machine configured to assemble the target assembly, based on the assembly sequence of the target assembly.
